(19) United States
(12) Patent Application Publication
(10) Pub. No.: US 2012/0312252 A1
(43) Pub. Date: Dec. 13, 2012

(54) LEASH FOR AN ANIMAL

(76) Inventor: Stephen A. Lipke, Raleigh, NC (US)

(21) Appl. No.: 13/155,958

(22) Filed: Jun. 8, 2011

(51) Int. Cl. A01K 27/00; B65H 75/34

(52) U.S. Cl. 119/796; 119/798

(57) ABSTRACT

A leash for an animal is provided. The leash includes a telescopic assembly configured for telescopic movement from a retracted position and an extended position. The leash includes a retractable cord assembly for tethering to an animal in which the cord assembly is at least partially received within the telescopic assembly and extends through a passage defined in the telescopic leash assembly.

### TECHNICAL FIELD

The presently disclosed subject matter is directed towards a leash for an animal, and more particularly, towards a leash for an animal that includes a telescopic assembly that receives a cord assembly therein for tethering to an animal.

### BACKGROUND

Leashes and other manners of tethering an animal are used when an animal owner wants to restrict movement of an animal such as, for example, while walking a pet animal for exercise.

Conventional leash assemblies may include a retractable amount of cord material that is attached to an animal on one end and held by a person on another. However, these conventional leash assemblies are undesirable in some instances because the animal is not restrained to being a certain distance away from the person. In these assemblies, the animal could come into contact with the person. This may be undesirable in situations in which, for example, the animal is hostile to the person, or the person does not want to come into contact with the animal when, for example, exercising such as jogging with the animal.

Rigid leash assemblies have been developed in which an elongate, rigid member may have a leash component on an end thereof for attaching to the animal. However, these assemblies are undesirable because the distance between the person and the animal is restricted by the length of the elongate, rigid member. If, for example, a person and an animal were jogging together, a mismatched pace between the person and the animal necessitates that one of the person or the animal is either pushing or pulling the elongate, rigid member.

Accordingly, a need exists for a leash assembly that addresses the problems associated with conventional leash assemblies.

### SUMMARY

According to one aspect of the disclosed subject matter, a leash for an animal is provided. The leash includes a telescopic assembly configured for telescopic movement from a retracted position and an extended position. The leash includes a retractable cord assembly for tethering to an animal and is at least partially received within the telescopic assembly and extends through a passage defined therein.

According to one aspect of the disclosed subject matter, the telescopic assembly includes an enclosure at about an end thereof that encloses the at least partially received retractable cord assembly.

According to one aspect of the disclosed subject matter, the enclosure defines a pin therein for rotatably receiving the cord assembly.

According to one aspect of the disclosed subject matter, the telescopic leash assembly includes a first sleeve and at least a second sleeve. One of the at least a second sleeve has a major outer diameter smaller than a major inner diameter of the passage of the first sleeve and is configured for slideable movement within the first sleeve.

According to one aspect of the disclosed subject matter, the first sleeve defines a shoulder and the one of the at least a second sleeve defines a channel on a circumferential surface thereof and is configured for receiving the shoulder and locking the first and the at least a second sleeve in the retracted or extended position.

According to one aspect of the disclosed subject matter, the channel is longitudinally extending about the at least a second sleeve.

According to one aspect of the disclosed subject matter, the channel defines a circumferentially extending portion about the at least a second sleeve and the at least a second sleeve is configured for rotational movement until the shoulder is in engagement with the circumferentially extending portion to thereby maintain the at least a second sleeve relative to the first sleeve.

According to one aspect of the disclosed subject matter, the one of the at least a second sleeve includes a pin on a distal end thereof configured for engagement with a fastener carried on a distal end of the first sleeve for maintaining the telescopic assembly in the retracted position.

According to one aspect of the disclosed subject matter, each of the first sleeve and the at least a second sleeve define a passage therein for at least partially receiving the cord assembly.

According to one aspect of the disclosed subject matter, the first sleeve and the at least a second sleeve are generally cylindrical.

According to one aspect of the disclosed subject matter, a leash assembly for an animal is provided. The leash assembly includes a housing defining an enclosure that receives a retractable cord assembly for tethering to an animal and a plurality of sleeves forming a telescopic assembly. The plurality of sleeves are configured for retractable movement in which each successive sleeve is configured for being received within each prior sleeve. The plurality of sleeves are carried in the housing when in a retracted position and each sleeve defines a passage therethrough in which the cord assembly extends.

According to one aspect of the disclosed subject matter, a leash for an animal is provided. The leash includes a housing defining an enclosure and receiving a retractable cord assembly therein for tethering to an animal and a telescopic assembly including a first sleeve and a second sleeve received within the first sleeve and configured for telescopic movement between a retracted position in which the telescopic assembly is received within the housing and an extended position in which a distal end of the first sleeve is in engagement with a proximal end of the second sleeve. Each of the first and second sleeves define a passage therethrough in which the cord assembly extends.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1A is a side view of a person using a leash to tether to an animal according to one or more embodiments of the presently disclosed subject matter in which a retractable cord assembly is extended;

FIG. 1B is a side view of a person using a leash to tether to an animal according to one or more embodiments of the presently disclosed subject matter in which a telescopic assembly is extended;

FIG. 1C is a side view of a person using a leash to tether to an animal according to one or more embodiments of the presently disclosed subject matter in which a retractable cord assembly and a telescopic assembly are extended;

FIG. 2 is a side facing, perspective view of a leash in a first position according to one or more embodiments of the presently disclosed subject matter;

FIG. 3 is a perspective view of a leash according to one or more embodiments of the presently disclosed subject matter in which a telescopic assembly is extended;

FIG. 4A is a front view of a leash in a retracted position according to one or more embodiments of the presently disclosed subject matter; and

FIG. 4B is a rear view of a leash according to one or more embodiments of the presently disclosed subject matter.

### DETAILED DESCRIPTION

The presently disclosed subject matter now will be described more fully hereinafter with reference to the accompanying drawings, in which some, but not all embodiments are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

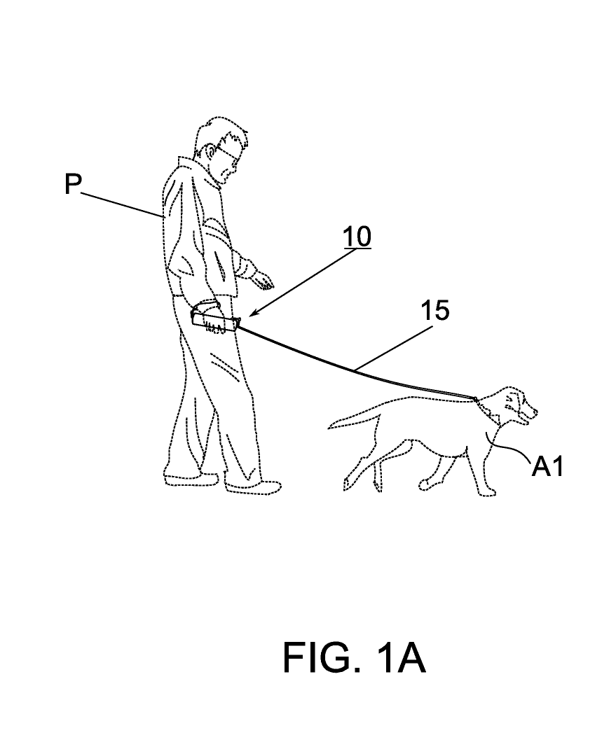

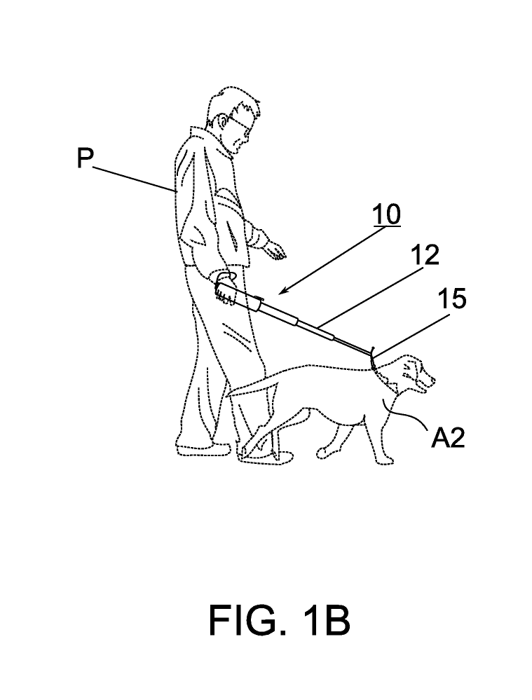

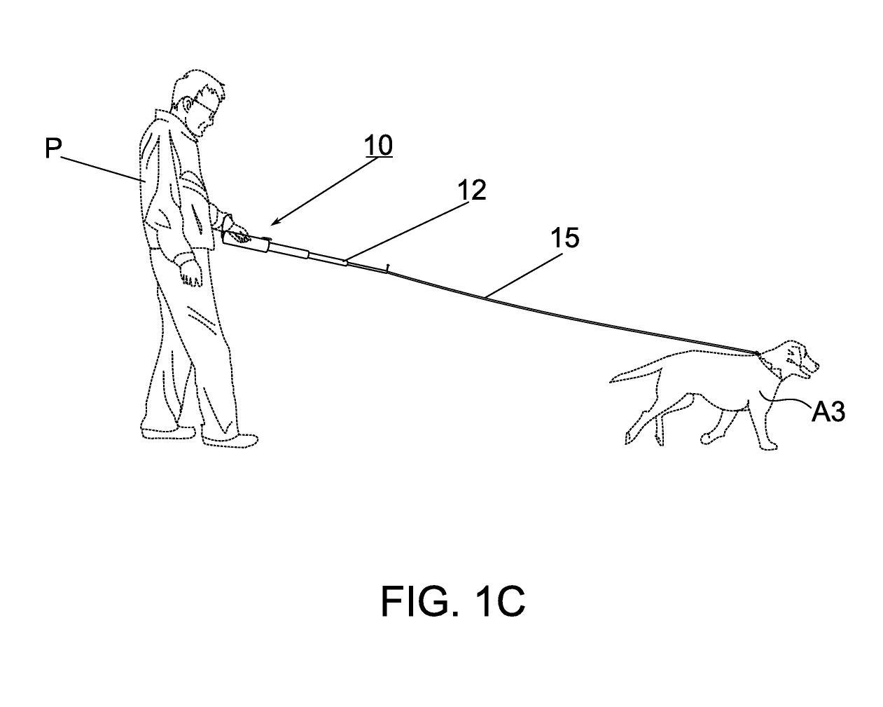

A leash for an animal is illustrated throughout the drawings and is generally designated 10. As illustrated in FIG. 1, the leash 10 is configured for having at least three distinct operating modes or positions. For example, in a first mode, the leash 10 is carried by a person “P” and is shown in a position in which a section of cord 15 is attached to an animal “A1.” In a second mode, the leash 10 is shown in an extended position in which a telescopic assembly 12 is extended but the cord 15 is not extended significantly beyond the end of the telescopic assembly 12 and where the cord 15 is attached to an animal “A2.” In a third mode, the leash 10 is shown in an extended position in which the telescopic assembly 12 is extended and the cord 15 is extended significantly beyond the end of the telescopic assembly 12 and is attached to an animal “A3.”

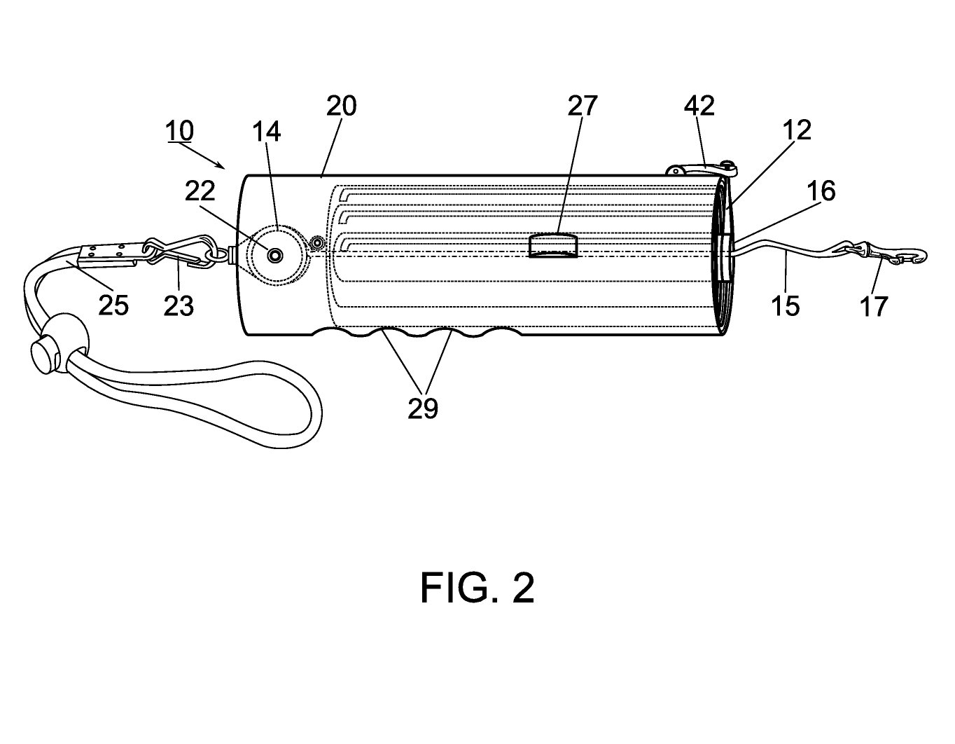

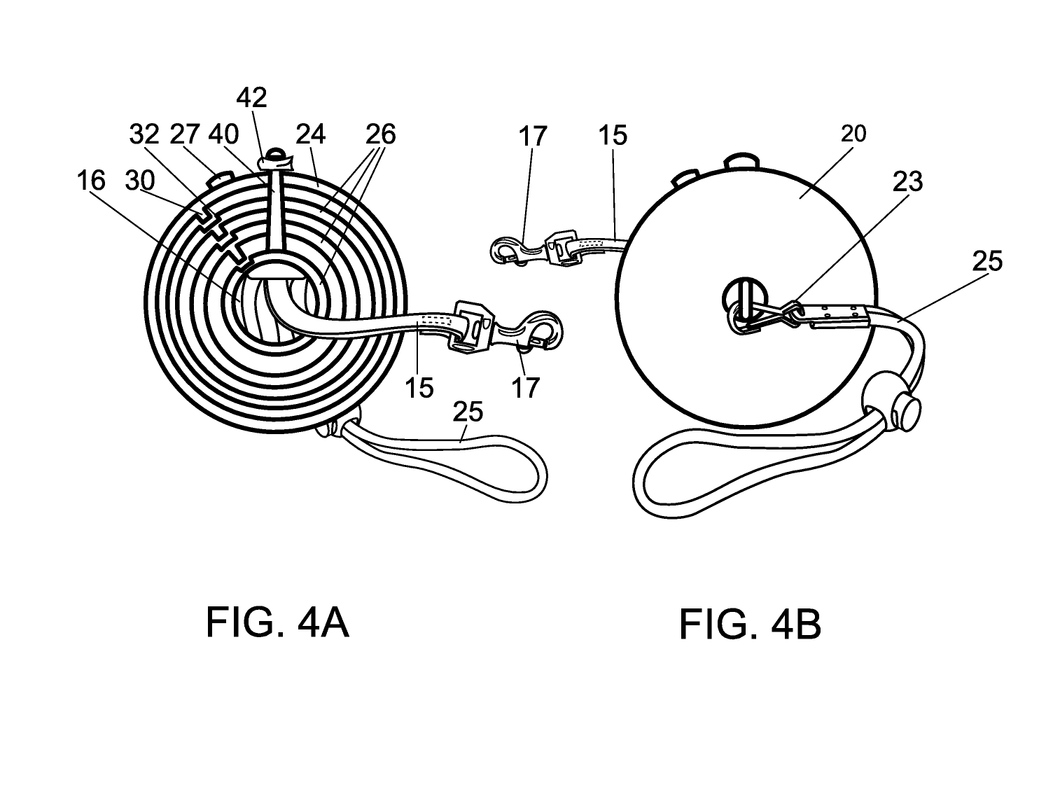

As illustrated more closely in FIGS. 2, 3, 4A, and 4B, the leash 10 includes the telescopic assembly 12. The telescopic assembly 12 is configured for telescopic movement from a retracted position, such as that illustrated in FIG. 1 with relation to animal “A1”, and an extended position, such as that illustrated in FIG. 1 with relation to animal “A2” or “A3.” The leash 10 includes a retractable cord assembly 14 for tethering to an animal. The cord assembly 14 may be at least partially received within the telescopic assembly 12 and may extend through a passage 16 defined therein.

The telescopic assembly 12 may be carried within an enclosure 20. The enclosure 20 may also carry the retractable cord assembly 14, which may be rotatably received on a pin 22 that extends through the enclosure 20. The retractable cord assembly 14 may be configured for allowing a predetermined amount of cord 15 to be extended and then retracted upon some user induced control. The enclosure 20 may include a button 27, which, in one or more embodiments may be for actuating the telescopic assembly 12, while, in one or more embodiments may be for actuating the retractable cord assembly 14, while, in one or more embodiments, may be for actuating the telescopic assembly 12 and the retractable cord assembly 14. The enclosure 20 may also define a plurality of hand grip recesses 29.

The cord assembly 14 may include the cord 15 and a fastener 17 on an end thereof. The cord assembly 14 may be provided with a sufficient length of cord 15 as desired. The cord assembly 14 may be retracted in any appropriate manner, such as, for example, by a coiled or spring-biased assembly that may include a ratchet and pawl type mechanism. A clip 23 may be attached to one end of either the enclosure 20 or the cord assembly 14 and may further include a loop of material 25 that is configured for engagement with, for example, a wrist of the person.

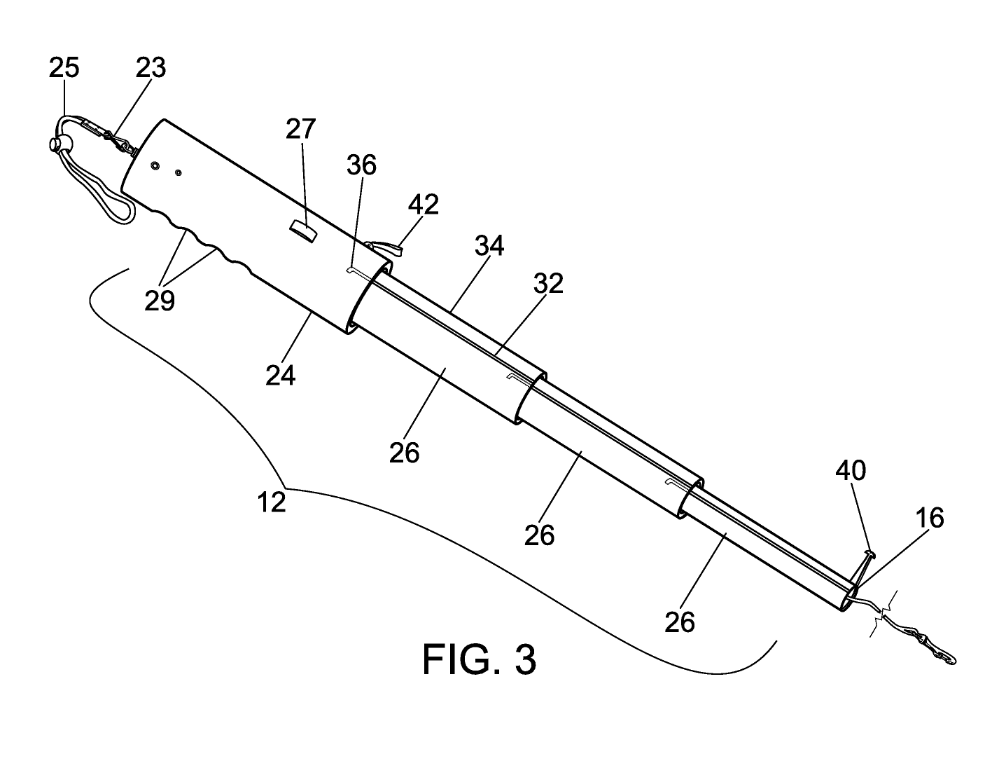

The telescopic assembly 12 may include a first sleeve 24 and at least a second sleeve 26. As used herein, the at least a second sleeve 24 may include a plurality of sleeves such as that which is illustrated in FIG. 3. The telescopic assembly 12 may be configured such that each successive sleeve is configured for being received within each prior sleeve. This may be configured in any appropriately configured way, and in one or more embodiments, may be configured such that the second sleeve 26 has a major outer diameter smaller than a major inner diameter of the passage 16 of the first sleeve 24. In this manner, the second sleeve 26 is configured for slideable movement within the first sleeve 24. The sleeves are illustrated as being generally cylindrical, but, in one or more embodiments, may take on any appropriately configured shape or configuration. The passage 16 may be defined in each of the sleeves.

In one or more embodiments, the first sleeve 24 may define a shoulder 30 that extends towards the second sleeve 26. The second sleeve 26 may define a channel 32 on a circumferential surface 34 of the second sleeve 26. The channel 32 may be provided for receiving the shoulder 30 in a manner similar to a “tongue and groove” type arrangement. In this manner, the engagement of the shoulder 30 and channel 32 may maintain the first sleeve 24 and second sleeve 26 in one of the desired modes or positions. Portions of the channel 32 are longitudinally extending about the second sleeve 26 such that the sleeve 26 is configured for generally linear movement relative to the first sleeve 24. In one or more embodiments, the channel 32 may include a circumferentially extending portion 36 which is illustrated in broken lines in FIG. 3. In these one or more embodiments, the second sleeve 26 is configured for rotational movement until the shoulder 30 is in engagement with the circumferentially extending portion 36 of the channel 32 to thereby maintain the second sleeve 26 relative to the first sleeve 24.

In one or more embodiments, the second sleeve 26 includes a pin 40 on a distal end thereof that is configured for engagement with a fastener carried 42 on a distal end of the first sleeve 24 for maintaining the telescopic assembly 12 in the retracted position.

The leash 10 may be configured to actuate from a desired mode or position by pressing button 27. For example, a biasing force may be provided in the enclosure 20 to bias the telescopic assembly 12 into the extended position when button 27 is pressed. The telescopic assembly 12 may then be maintained in the extended position by engagement of shoulder 30 and channel 32. The telescopic assembly 12 may then be returned to the retracted position by manually sliding the sleeves 26 into the enclosure 20. In one or more embodiments, the retractable cord assembly 14 may be actuated by the button 27 such that pressing the button may actuate a recoiled assembly or the like for retracting the cord 15 or for extending the cord 15.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A leash for an animal, comprising:
a telescopic assembly configured for telescopic movement from a retracted position and an extended position; and
a retractable cord assembly for tethering to an animal and being at least partially received within the telescopic assembly and extending through a passage defined therein.

2. The leash according to claim 1, wherein the telescopic assembly further comprises an enclosure at about an end thereof that encloses the at least partially received retractable cord assembly.

3. The leash according to claim 2, wherein the enclosure defines a pin therein for rotatably receiving the cord assembly.

4. The leash according to claim 1, wherein the telescopic leash assembly comprises a first sleeve and at least a second sleeve, wherein one of the at least a second sleeve has a major outer diameter smaller than a major inner diameter of the passage of the first sleeve and is configured for slideable movement within the first sleeve.

5. The leash according to claim 4, wherein the first sleeve defines a shoulder and the one of the at least a second sleeve defines a channel on a circumferential surface thereof and is configured for receiving the shoulder and locking the first sleeve and the at least a second sleeve in the retracted or extended position.

6. The leash according to claim 5, wherein the channel is longitudinally extending about the at least a second sleeve.

7. The leash according to claim 6, wherein the channel defines a circumferentially extending portion about the at least a second sleeve, and further wherein, the at least a second sleeve is configured for rotational movement until the shoulder is in engagement with the circumferentially extending portion to thereby maintain the at least a second sleeve relative to the first sleeve.

8. The leash according to claim 4, wherein the one of the at least a second sleeve comprises a pin on a distal end thereof configured for engagement with a fastener carried on a distal end of the first sleeve for maintaining the telescopic assembly in the retracted position.

9. The leash according to claim 4, wherein each of the first sleeve and the at least a second sleeve define a passage therein for at least partially receiving the cord assembly.

10. The leash according to claim 4, wherein the first sleeve and the at least a second sleeve are generally cylindrical.

11. A leash assembly for an animal, comprising:
a housing defining an enclosure that receives a retractable cord assembly for tethering to an animal; and
a plurality of sleeves forming a telescopic assembly, the plurality of sleeves configured for retractable movement in which each successive sleeve is configured for being received within each prior sleeve,
wherein the plurality of sleeves are carried in the housing when in a retracted position and each sleeve defines a passage therethrough in which the cord assembly extends.

12. The leash according to claim 11, wherein the enclosure defines a pin therein for rotatably receiving the cord.

13. The leash according to claim 12, wherein the plurality of sleeves include a first sleeve and at least a second sleeve, and further wherein the first sleeve defines a shoulder and the one of the at least a second sleeve defines a channel configured for receiving the shoulder and locking the first and the at least a second sleeve in the retracted or extended position.

14. The leash according to claim 13, wherein the channel is longitudinally extending about the at least a second sleeve.

15. The leash according to claim 14, wherein the channel defines a circumferentially extending portion about the at least a second sleeve, and further wherein, the at least a second sleeve is configured for rotational movement until the shoulder is in engagement with the circumferentially extending portion to thereby maintain the at least a second sleeve relative to the first sleeve.

16. The leash according to claim 12, wherein the one of the at least a second sleeve comprises a pin on a distal end thereof configured for engagement with a fastener carried on a distal end of the first sleeve for maintaining the telescopic assembly in the retracted position.

17. The leash according to claim 12, wherein each of the first sleeve and the at least a second sleeve define a passage therein for at least partially receiving the cord assembly.

18. The leash according to claim 12, wherein the first sleeve and the at least a second sleeve are generally cylindrical.

19. A leash for an animal, comprising:
a housing defining an enclosure and receiving a retractable cord assembly therein for tethering to an animal; and
a telescopic assembly including a first sleeve and a second sleeve received within the first sleeve and configured for telescopic movement between a retracted position in which the telescopic assembly is received within the housing and an extended position in which a distal end of the first sleeve is in engagement with a proximal end of the second sleeve, each of the first and second sleeves defining a passage therethrough in which the cord assembly extends.
